(19) United States
(12) Patent Application Publication
(10) Pub. No.: US 2025/0130428 A1
(43) Pub. Date: Apr. 24, 2025

(54) REFERENCE PROJECTION FOR A WEARABLE DISPLAY

(71) Applicant: GOOGLE LLC, Mountain View, CA (US)

(72) Inventors: Daniel Adema, Kitchener (CA); Shreyas Potnis, Kitchener (CA)

(21) Appl. No.: 18/921,196

(22) Filed: Oct. 21, 2024

Related U.S. Application Data
(60) Provisional application No. 63/591,870, filed on Oct. 20, 2023.

(51) Int. Cl. G02B 27/01; H04N 19/895

(52) U.S. Cl. CPC G02B 27/0172; H04N 19/895; G02B 2027/0178; G02B 2207/101

(57) ABSTRACT

According to an aspect, a method includes generating a first projection from a first image source, the first projection displayed on a surface of a device. The method further includes generating a second projection from a second image source, the second projection displayed on the surface of the device. The method also includes identifying at least one error in an alignment associated with the first image source based on the first projection and the second projection.

### CROSS-REFERENCE TO RELATED APPLICATION

This application claims priority to U.S. Provisional Patent Application No. 63/591,870, filed on Oct. 20, 2023, entitled “NOSE-BRIDGE REFERENCE FOR TEMPLE PROJECTION IN AR/VR DISPLAYS,” the disclosure of which is incorporated by reference herein in its entirety.

### BACKGROUND

Extended Reality (XR) displays, which include virtual reality (VR), augmented reality (AR), and mixed reality (MR) devices, work by creating immersive or augmented environments through high-resolution screens or projections. These displays can use Organic Light Emitting Diode (OLED), Micro Light Emitting Diode (microLED), Liquid Crystal Display (LCD), or another display technology housed inside headsets or smart glasses to project images directly into the user's field of view. In VR, the display fully immerses the user in a digital environment by covering the visual field with three-dimensional content. In AR, the display overlays digital information onto the physical world through transparent or semi-transparent lenses. XR displays rely on sensors like cameras, gyroscopes, and accelerometers to track head movement, adjust the view dynamically, and provide a seamless, interactive experience.

### SUMMARY

This disclosure relates to systems and methods for aligning projector systems in an XR device. In some implementations, an XR device is configured with a binocular display system. A binocular display system is a visual setup on XR devices that presents separate images to each eye to create a three-dimensional effect, simulating depth perception for an immersive experience. In some examples, an XR device is configured with a first image source or projector and a second image source or projector. A system can use the second image source to align the first image source by comparing the projections from each image source. For example, the first image source can generate a first projection, and the second image source can generate a second projection. A system can be configured to compare the first and second projections to identify at least one error in the alignment associated with the first projection. From at least one error, the system can be configured to update a configuration associated with the first image source to correct the error.

In some aspects, the techniques described herein relate to a method including: generating a first projection from a first image source, the first projection displayed on a surface of a device; generating a second projection from a second image source, the second projection displayed on the surface of the device; and identifying at least one error in an alignment associated with the first image source based on the first projection and the second projection.

In some aspects, the techniques described herein relate to a computer-readable storage medium having program instructions stored thereon that, when executed by at least one processor, direct the at least one processor to perform a method, the method including: generating a first projection from a first image source, the first projection displayed on a surface of a device; generating a second projection from a second image source, the second projection displayed on the surface of the device; and identifying at least one error in an alignment associated with the first image source based on the first projection and the second projection.

In some aspects, the techniques described herein relate to a system including: a computer-readable storage medium; at least one processor operatively coupled to the computer-readable storage medium; and program instructions stored on the computer-readable storage medium that, when executed by the at least one processor, direct the at least one processor to perform a method, the method including: generating a first projection from a first image source, the first projection displayed on a surface of a device; generating a second projection from a second image source, the second projection displayed on the surface of the device; and identifying at least one error in an alignment associated with the first image source based on the first projection and the second projection.

The accompanying drawings and the description below set forth the details of one or more implementations. Other features will be apparent from the description, drawings, and claims.

### BRIEF DESCRIPTION OF THE DRAWINGS

FIG. 1 illustrates an XR device according to an implementation.

FIG. 2 illustrates an operational scenario of providing a reference projection on an XR device according to an implementation.

FIG. 3 illustrates a method of updating a configuration associated with an image source according to an implementation.

FIG. 4 illustrates an operational scenario of updating a configuration associated with an image source according to an implementation.

FIG. 5 illustrates a computing system to update a configuration associated with an image source on an XR device according to an implementation.

### DETAILED DESCRIPTION

This disclosure relates to systems and methods for managing the alignment of projector systems on an XR device. An XR device can include components to immerse users in virtual, augmented, or mixed experiences. The hardware elements of XR devices can consist of high-resolution displays (for VR headsets) or transparent lenses (for AR glasses) to project virtual content. These are accompanied by sensors, such as cameras, accelerometers, gyroscopes, and proximity sensors, to track head movements, gestures, and the user's surroundings. In some examples, high-fidelity audio systems and spatial sound support can improve the auditory aspect of the experience, adding to immersion. Controllers or hand-tracking sensors allow users to interact with virtual objects, while haptic feedback systems can provide tactile sensation.

In some implementations, an XR device includes a binocular display system. A binocular display system for an XR device is a setup that presents two separate images, one for each eye, creating a stereoscopic effect that mimics natural human binocular vision. This system can improve depth perception and spatial awareness, making virtual objects appear three-dimensional and realistic to the user. Each display projects slightly different angles of the same scene to each eye, simulating how humans perceive depth in the real world. Binocular display systems contribute to the immersive experience of an XR device by improving visual realism and reducing eye strain during extended use. However, at least one technical problem exists in aligning the left and right eye projectors to provide the desired display.

In some implementations, alignment issues in binocular displays occur when the images presented to each eye are not properly aligned, leading to visual discomfort and distorted depth perception. These issues can result in double vision, eye strain, headaches, or nausea due to a mismatch between the visual cues the brain expects and what the device provides. In some examples, misalignment can be caused by improper display calibration, optical distortions, or tracking errors.

In at least one technical solution, an XR device is configured with multiple projector systems that each include at least one image source. In some implementations, a first projector system is located near the temple area of the XR device, which is near the side of the user's head. In some implementations, the second projector system is located near the bridge of the XR device. The bridge of an XR device is the part that rests on the user's nose, connecting the two sides of the device and helping to stabilize and balance it for the user to wear. In some implementations, the first projector system is aligned using the second projector system. In at least one example, the first projector system generates a first projection, and the second projector system generates a second projection. The first and second projections can comprise one or more shapes (e.g., crosshairs, circles, etc.) that can be compared to identify misalignments associated with the first projector. For example, the first projection may not align with the second projection. In response to the misalignment, the system can determine an update to the configuration of the first projector system to improve the alignment of the first and second projections.

In some examples, a user can perform an alignment test on the XR device. The XR device will generate a first projection from the first image source and a second projection from the second image source. The user can use gestures, a keyboard, physical buttons, or some other input to adjust the configuration of the first image source to improve the alignment of the first projection and the second projection.

In some implementations, an XR device can generate a first projection from the first image source and a second projection from the second image source. A system comprising one or more other cameras or sensors can capture the displayed first and second projections and use the information from the capture to determine the misalignment (i.e., error). In some examples, the cameras capture the view like the user of the XR device and the system determines one or more adjustments to the configuration of the first image source to improve the alignment. The update can include shifting the image position (horizontal, vertical, or depth), scaling, rotating, or some other update to the configuration associated with the image source. The update can be implemented via the XR device's actuators, motors, or other elements.

In some examples, the alignments for the projectors for the right and left eyes are updated independently. For example, a configuration associated with an image source for the right eye can be updated separately from the left eye. As a technical effect, the left and right eye projector system configurations can be updated based on the individual hardware requirements.

In some implementations, the second image source, or the image source used to align the first image source, provides a lower resolution than the first image source. As a technical effect, the second image source may use reduced power consumption and limit additional weight and size to the device. In some implementations, the second image source displays on a first portion of the lens or display on the device, while the first image source can display on a second portion of the lens or display. In some examples, the first portion is smaller than the second portion. As a technical effect, the second image source can align the first image source while limiting the weight and complexity associated with the additional image source.

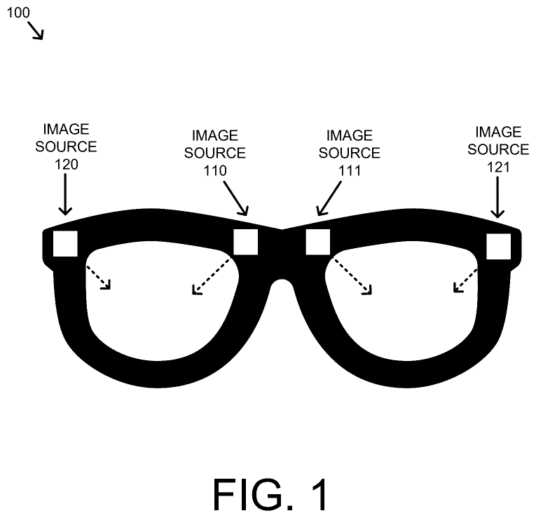

FIG. 1 illustrates an XR device 100 according to an implementation. XR device 100 includes image sources 110, 111, 120, and 121. XR device 100 can include hardware components designed to enable immersive experiences. The hardware can include lenses or screens, often placed directly in front of the user's eyes in VR headsets or as transparent lenses in AR and MR devices. These displays can be coupled with sensors, such as accelerometers, gyroscopes, and magnetometers, which track head and body movements, allowing the device to adjust the virtual content accordingly. Cameras and depth sensors can also be used, especially in AR and MR devices, to capture the surrounding environment and integrate virtual objects into the real world. XR devices can also be configured with built-in speakers or spatial audio systems to provide immersive soundscapes.

Additionally, XR devices can include processors and graphic processing units (GPUs) to render complex virtual environments and interactive elements. These processors enable the device to track user inputs, process visual and spatial data, and update the virtual content. Handheld controllers or hand-tracking sensors can be used for input, allowing users to interact with digital objects through natural movements. Some devices can also incorporate eye-tracking sensors to enhance precision and provide more intuitive control.

For XR device 100, image sources 110, 111, 120, and 121. The image sources create a binocular display by projecting two slightly different images for each eye onto the lenses or screens of XR device 100. This mimics how human eyes perceive depth by receiving slightly different perspectives of the same scene. This stereoscopic effect enables depth perception, enhancing the sense of immersion in virtual or augmented environments. In the example of XR device 100, image sources 110-111 and the optics for the projector are used to align image sources 120-121. In some implementations, in the example of image source 120 and image source 110, image source 120 and image source 110 each generate a projection displayed on a surface. The surface can comprise a waveguide, a lens, or some other surface. Once the first projection from image source 120 and the second projection from image source 110 are displayed, one or more misalignments or errors can be identified in the alignment of image source 120. In some examples, the second projection from image source 110 is used as a truth image to correct the alignment associated with the projection from image source 120.

In at least one implementation, image source 120 provides a first projection, and image source 110 provides a second projection. In some examples, each of the projections includes one or more shapes. Based on the overlap or location of the shapes in the first and second projections, an alignment error can be identified in association with image source 120. For example, when the first projection does not match the second projection and is lower than the first projection, an alignment error can be identified for image source 120.

In some implementations, a system can act as a human eye to test the alignment using one or more computing devices, cameras, or other sensors. The system can analyze position, angle, or distortion discrepancies between the first and second projections. In some examples, the system can compare key points or objects, such as borders or projected markers between the projections, and measure the difference to identify the misalignment. Once identified, the system can configure the XR device to rectify the misalignment. The system can configure the XR device using actuators, motors, control systems, and the like. The modification can include adjusting physical position, lens shift, and keystone settings associated with image source 120.

In some implementations, the user can request a calibration associated with XR device 100. In response to the request, XR device 100 can generate a first projection from image source 120 and a second projection from image source 110. The user can use gestures, controllers, a keyboard, or some other input mechanism to adjust the alignment of image source 120 and rectify the misalignment. For example, if the user determines that the projection from image source 120 is left of the projection from image source 110, the user can provide inputs to shift the optical output from image source 120. The shift can be accomplished via actuators, lens shift, windows, waveguides, or some other process to shift the output associated with image source 120.

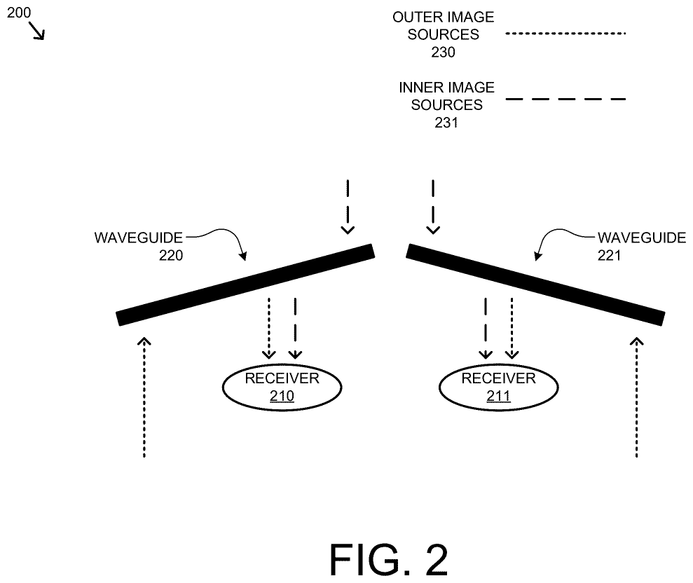

FIG. 2 illustrates an operational scenario 200 of providing a reference projection on an XR device according to an implementation. Operational scenario 200 receivers 210-211, waveguides 220-221, outer image sources 230, and inner image sources 231. Receivers 210-211 can represent a user's eyes or cameras that can capture the projections from outer image sources 230 and inner image sources 231 like a user's eyes. Outer image sources 230 and inner image sources 231 represent projection systems for an XR device. Outer image sources 230 are devices designed to project two separate images simultaneously, one for each eye, creating a stereoscopic three-dimensional effect for the viewer. Inner image sources 231 align outer image sources 230 in some examples by providing projections that can be compared to those from outer image sources 230. In some implementations, inner image sources 231 are closer to the bridge of the device than outer image sources 230.

In operational scenario 200, an XR device generates projections using outer image sources 230 and inner image sources 231. The projections are viewable by receivers 210-211. Receiver 210 can view left-side or left-eye content, while receiver 211 can view right-side or right-eye content for the XR device. Projecting on a waveguide, such as waveguides 220-221, on an XR device involves directing light through a transparent, layered optical element that guides and bends the light toward the user's eyes, creating augmented or mixed-reality visuals. Although demonstrated using waveguides, the projections from outer image sources 230 and inner image sources 231 can be on other surfaces, such as a screen in some examples.

Once the projections are generated, receiver 210 and receiver 211 can be used to update the alignment associated with outer image sources 230. In at least one implementation, the images captured by receivers 210-211 can be processed to determine misalignment between the inner image source and the outer image source. In at least one implementation, the projection created by the inner image source is considered the truth for alignment, and the alignment configuration of the outer image source is updated to reflect the inner image source. The outer image source can be misaligned due to a variety of factors including defects in manufacturing the frame of the XR device, natural movement of the XR device, or some other factor.

Based on comparing the projection from the outer image source to the projection from the inner image source, the system can determine the misalignment for the outer image source. In some implementations, when receivers 210-211 represent a user's eyes, the user can visually determine the misalignment and provide input to adjust the configuration of the outer image source to improve the alignment. In some examples, the projections from the inner and outer image sources can include key features or shapes that can indicate the alignment of the image sources. The user can adjust the orientation or lens configuration associated with the outer image source, permitting the projection from the outer image source to match the projection of the inner image source (i.e., match the ground truth provided by the inner image source).

In some implementations, one or more computing devices or cameras can be configured to update the configuration of the outer image sources 230. For example, receivers 210-211 can represent cameras or other sensors that capture the projections generated from outer image sources 230 and inner image sources 231. The captured images can be processed to determine at least one error in the alignment of an outer image source. In some implementations, alignment between two overlapping projectors can be tested by projecting a test pattern (or image keys), such as a grid or crosshatch, and using visual inspection or camera-based software to detect misalignments in geometry, color, and brightness. The system compares the projected images, identifying discrepancies in overlap, distortion, or edge blending, and adjustments are made to achieve the desired alignment. The adjustments can include modifying the physical positioning of the image source, adjusting keystone correction, modifying lens shift, updating zoom or focus, using edge blending or warping, or some other modification in association with the image source.

In some examples, inner image sources 231 can provide a different or lesser resolution than outer image sources 230. The reduced resolution can reduce weight and power requirements associated with inner image sources 231, while permitting the inner image sources to provide test patterns for aligning outer image sources 230. In some implementations, inner image sources 231 may display on a first portion of the user display or waveguide, while outer image sources 230 are displayed on a second portion of the user display. In some examples, the first portion comprises a smaller portion of the display than the

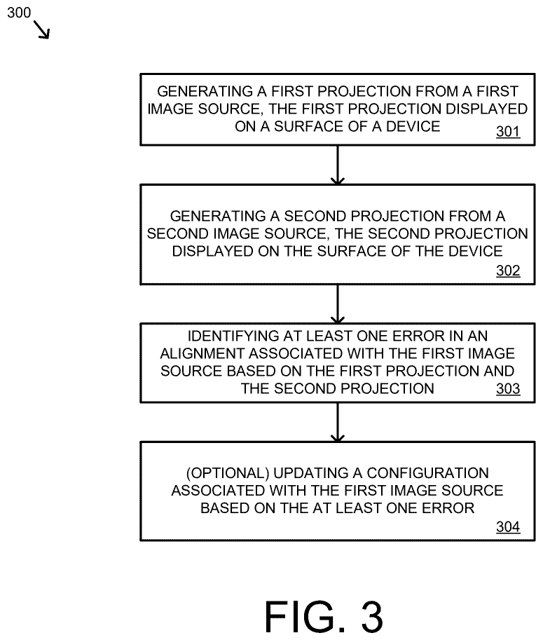

FIG. 3 illustrates method 300 of updating a configuration associated with an image source according to an implementation. The steps of method 300 is referenced parenthetically in the paragraphs that follow with reference to systems and elements of operational scenario 200 of FIG. 2.

Method 300 includes generating (301) a first projection from a first image source, the first projection displayed on a surface of a device. The method further includes generating (302) a second projection from a second image source, the second projection displayed on the surface of the device. In some implementations, a device includes two image sources corresponding to two projectors for each eye. The first image source, located near the user's temple, provides the imaging associated with the binocular display. The second image source, which can be located near the bridge of the device, is used to test the alignment associated with the first image source. In some implementations, each image source directs light into one or more waveguides, which guide and diffract the light to create and overlay an image onto the user's field of view. In other examples, the projections may also be placed on a lens, screen, or other surface.

Referring to an example in operational scenario 200, outer image sources 230 provide a binocular display system for an XR device. A binocular display system on an XR device uses two separate displays or projections, one for each eye, to create a stereoscopic three-dimensional effect. This system mimics natural human binocular vision, providing depth perception and an immersive visual experience in the virtual or augmented environment. In operational scenario 200, outer image sources 230 are used to project an image into waveguides 220-221 to produce an image in a user's field of view. Additionally, inner image sources 231 can project a truth image on waveguides 220-221 to align outer image sources 230.

Method 300 further includes identifying (303) at least one error in an alignment associated with the first image source based on the first projection and the second projection. In some implementations, a system includes one or more computing devices, cameras, and other sensors. In some examples, the system is operatively coupled to the XR device to identify the at least one error and update the configuration associated with the first image source. To determine the error, the system can use cameras that capture the first and second projections. In some implementations, the XR device generates first and second projections, including test patterns, such as grids or crosshatch patterns. The captured images of the test patterns are processed to identify misalignments in these patterns, such as distortion or offset between corresponding lines or points. The system can detect positional differences which indicate errors associated with the alignment of the first image source because the projection from second image source is taken as the truth. Once the at least one error is determined, method 300 further includes updating (304) a configuration associated with the first image source based on the at least one error. The update to the configuration can include shifting the image position (horizontal, vertical, or depth), scaling, rotating, keystone correction, and tuning the focus to adjust the alignment of the first image source to the second image source. For example, the projection from the first image source can be adjusted directionally to align with the projection from the second image source.

In some implementations, users can update the alignment associated with the first image source. For example, a user can request the XR device display the first and second projections (e.g., test patterns) to determine the alignment associated with the first image source. The user can provide feedback using one or more input mechanisms to adjust the configuration related to the first image source to align with the second image source. The update can include shifting the image position (horizontal, vertical, or depth), scaling, rotating, keystone correction, and tuning the focus to adjust the alignment of the first image source to the second image source. In some examples, the user can manually generate requests to align the projector system. In other implementations, the XR device can initiate the alignment process, where the alignment can occur when the XR device initially powers on for the user, periodically for the user, or at some other interval.

In some examples, the second projection has a different resolution than the first. Specifically, the first projection can include a first resolution, and the second projection can comprise a second resolution less than the first resolution. Limiting the resolution associated with the second projection can reduce hardware and battery requirements for the second image source.

In some implementations, in addition to or in place of reducing the resolution associated with the second image source relative to the first image source, an XR device can be configured with the second image source occupying a portion of the surface (screen, waveguide, etc.) that is smaller than the first image source. The reduced size of the projection can reduce the resolution, battery requirements, size, or other hardware requirements for the projector associated with the second image source.

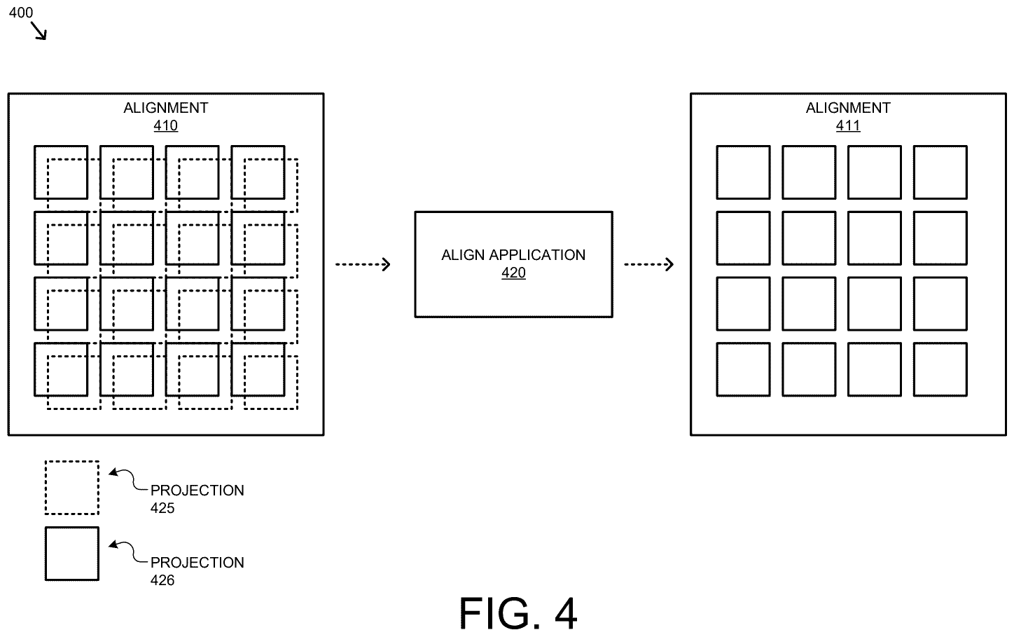

FIG. 4 illustrates an operational scenario 400 of updating a configuration associated with an image source according to an implementation. Operational scenario 400 includes alignment 410, align application 420, and alignment 411. Operational scenario 400 further includes projection 425 and projection 426, where projection 425 represents a projection from a first projector (i.e., image source) and projection 426 is representative of a projection from a second projector. In some implementations, projection 426 is representative of a projection from a first projector that provides a truth image to which a second projector can be aligned. For example, the first projector can be closer to the nose bridge of an XR device than the second projector. In some implementations, the second projector may be nearer to the temple portion of the XR device than the first projector.

As demonstrated in operational scenario 400, projection 425 and projection 426 are generated by projectors on a left or right display of a binocular display system. A binocular display system creates different images for each eye to simulate depth perception, enabling a three-dimensional effect. These images are focused and aligned by optical lenses, correcting distortion and ensuring each eye sees its image. The brain then combines these two images to create a sense of depth and immersion, mimicking natural binocular vision. Here, projection 425 and projection 426 are representative of alignment projections for a single eye in the binocular display system.

Once projection 425 and projection 426 are provided at alignment 410, align application 420 is performed by a system. The system can include the XR device in some examples. In some implementations, the system can include one or more cameras, sensors, or computing devices that capture alignment 410 and process the alignment to generate alignment 411. In at least one example, align application 420 can be configured to use test patterns, such as grids or crosshatch patterns (demonstrated in alignment 410), projected by both devices. By observing misalignments in these patterns, such as distortion or offset between corresponding lines or points, align application can detect the positional differences or errors. Align application 420 can be configured to update the configuration of the projector for the display (e.g., the temple projector) based on the identified errors. The update can include shifting the image position (horizontal, vertical, or depth), scaling, rotating, or some other update to the configuration. The update can be implemented via actuators, motors, or other elements on the XR device.

In some implementations, the device user can replace the cameras and sensors capturing alignment 410. The user can identify the misalignment between the projector systems and update the projector configuration using one or more inputs to provide alignment 411. Thus, rather than using additional cameras, the user can give input to change the configuration associated with the image source and projection system.

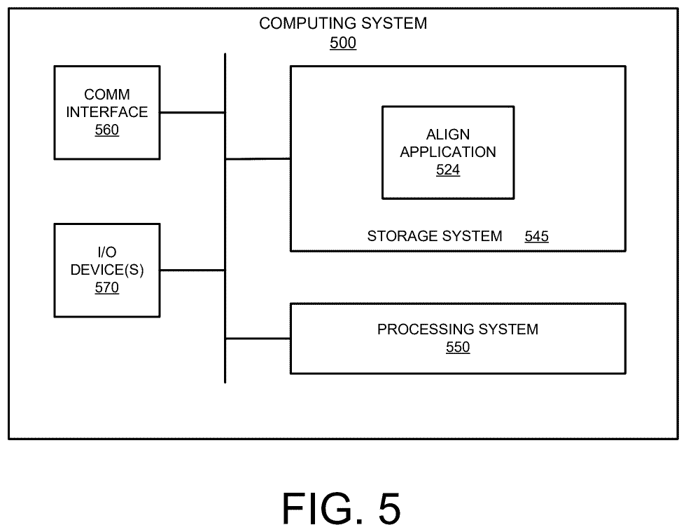

FIG. 5 illustrates a computing system 500 that updates a configuration associated with an image source on an XR device according to an implementation. Computing system 500 can represent any computing system or systems with which the various operational architectures, processes, scenarios, and sequences disclosed herein for updating an alignment for an XR device may be implemented. Computing system 500 includes storage system 545, processing system 550, communication interface 560, input/output (I/O) device(s) 570. Processing system 550 is operatively linked to communication interface 560, I/O device(s) 570, and storage system 545. In some implementations, communication interface 560 and/or I/O device(s) 570 may be communicatively linked to storage system 545. Computing system 500 may further include other components such as a battery and enclosure that are not shown for clarity.

Communication interface 560 comprises components that communicate over communication links, such as network cards, ports, radio frequency, processing circuitry and software, or some other communication devices. Communication interface 560 may be configured to communicate over metallic, wireless, or optical links. Communication interface 560 may be configured to use Time Division Multiplex (TDM), Internet Protocol (IP), Ethernet, optical networking, wireless protocols, communication signaling, or some other communication format-including combinations thereof. Communication interface 560 may be configured to communicate with external devices, such as servers, user devices, or other computing devices. In some implementations, communication interface 560 can communicate with cameras, sensors, and the like to capture and process misalignment identified in the projecting systems.

I/O device(s) 570 may include computer peripherals that facilitate the interaction between the user and computing system 500. Examples of I/O device(s) 570 may include keyboards, mice, trackpads, monitors, displays, printers, cameras, microphones, external storage devices, and the like. In some implementations, I/O device(s) 570 include display systems and processors to provide a user with a binocular display.

Processing system 550 comprises microprocessor circuitry (e.g., at least one processor) and other circuitry that retrieves and executes operating software (i.e., program instructions) from storage system 545. Storage system 545 may include volatile and nonvolatile, removable, and non-removable media implemented in any method or technology for storage of information, such as computer-readable instructions, data structures, program modules, or other data. Storage system 545 may be implemented as a single storage device and across multiple storage devices or sub-systems. Storage system 545 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be a non-transitory storage media. In some instances, at least a portion of the storage media may be transitory. In no case is the storage media a propagated signal.

Processing system 550 is typically mounted on a circuit board that may also hold the storage system. The operating software of storage system 545 comprises computer programs, firmware, or some other form of machine-readable program instructions. The operating software of storage system 545 comprises align application 524. The operating software on storage system 545 may include an operating system, utilities, drivers, network interfaces, applications, or some other type of software. When read and executed by processing system 550 the operating software on storage system 545 directs computing system 500 to operate as a computing device as described herein. The operating software can provide at least method 300 of FIG. 3 in at least one implementation.

In at least one example, align application 524 directs processing system 550 to generate a first projection from a first image source, the first projection displayed on a surface of a device, and generate a second projection from a second image source, the second projection displayed on the surface of the device. Align application 524 further directs processing system 550 to identify at least one error in an alignment associated with the first image source based on the first projection and the second projection. Align application 524 further directs processing system 550 to update a configuration associated with the first image source based on the at least one error.

In some implementations, the first image source corresponds to a temple portion of an XR device on a right or left side. In some implementations, the second image source is closer to the bridge portion of the XR device than the first image source. In some examples, the first image source has a higher resolution than the second. In some examples, the first image source occupies a first portion of the surface (i.e., display, screen, waveguide) and the second image source occupies a second portion. The second portion can represent a smaller portion of the surface in some examples.

In some implementations, the configuration update can include shifting the image position (horizontal, vertical, or depth), scaling, rotating, or some other update to the configuration. The update can be implemented via actuators, motors, or other elements on the XR device.

Clause 1. A method comprising: generating a first projection from a first image source, the first projection displayed on a surface of a device; generating a second projection from a second image source, the second projection displayed on the surface of the device; and identifying at least one error in an alignment associated with the first image source based on the first projection and the second projection.

Clause 2. The method of clause 1 further comprising: updating a configuration associated with the first image source based on the at least one error.

Clause 3. The method of clause 2, wherein the configuration comprises an orientation of the first image source.

Clause 4. The method of clause 1, wherein the device comprises an extended reality device, and wherein the second image source is closer to a bridge of the extended reality device than the first image source.

Clause 5. The method of clause 1, wherein the first image source provides a first resolution, and wherein the second image source provides a second resolution.

Clause 6. The method of clause 5, wherein the first resolution comprises a higher resolution than the second resolution.

Clause 7. The method of clause 1, wherein the first projection occupies a first portion of the surface, and wherein the second projection occupies a second portion of the surface.

Clause 8. The method of clause 1, wherein identifying the at least one error in the alignment associated with the first image source based on the first projection and the second projection comprises: determining an offset of the first projection from the second projection.

Clause 9. A computer-readable storage medium having program instructions stored thereon that, when executed by at least one processor, direct the at least one processor to perform a method, the method comprising: generating a first projection from a first image source, the first projection displayed on a surface of a device; generating a second projection from a second image source, the second projection displayed on the surface of the device; and identifying at least one error in an alignment associated with the first image source based on the first projection and the second projection.

Clause 10. The computer-readable storage medium of clause 9, wherein the method further comprises: updating a configuration associated with the first image source based on the at least one error.

Clause 11. The computer-readable storage medium of clause 10, wherein the configuration comprises a projection of the first image source.

Clause 12. The computer-readable storage medium of clause 9, wherein the device comprises an extended reality device, and wherein the second image source is closer to a bridge of the extended reality device than the first image source.

Clause 13. The computer-readable storage medium of clause 9, wherein the first image source provides a first resolution, and wherein the second image source provides a second resolution.

Clause 14. The computer-readable storage medium of clause 13, wherein the first resolution comprises a higher resolution than the second resolution.

Clause 15. The computer-readable storage medium of clause 9, wherein the first projection occupies a first portion of the surface, and wherein the second projection occupies a second portion of the surface.

Clause 16. The computer-readable storage medium of clause 9, wherein identifying the at least one error in the alignment associated with first image source based on the first projection and the second projection comprises: determining an offset of the first projection from the second projection.

Clause 17. A system comprising: a computer-readable storage medium; at least one processor operatively coupled to the computer-readable storage medium; and program instructions stored on the computer-readable storage medium that, when executed by the at least one processor, direct the at least one processor to perform a method, the method comprising: generating a first projection from a first image source, the first projection displayed on a surface of a device; generating a second projection from a second image source, the second projection displayed on the surface of the device; and identifying at least one error in an alignment associated with the first image source based on the first projection and the second projection.

Clause 18. The system of clause 17, wherein the method further comprising: updating a configuration associated with the first image source based on the at least one error.

Clause 19. The system of clause 17, wherein the system further comprises: the first image source operatively coupled to the at least one processor; and the second image source operatively coupled to the at least one processor.

Clause 20. The system of clause 17, wherein the first image source provides a first resolution, and wherein the second image source provides a second resolution.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing aspects and is not intended to be limiting. On the contrary, this patent covers all methods, apparatus and articles of manufacture fairly falling within the scope of the claims of this patent.

What is claimed is:

1. A method comprising:
generating a first projection from a first image source, the first projection displayed on a surface of a device;
generating a second projection from a second image source, the second projection displayed on the surface of the device; and
identifying at least one error in an alignment associated with the first image source based on the first projection and the second projection.

2. The method of claim 1 further comprising:
updating a configuration associated with the first image source based on the at least one error.

3. The method of claim 2, wherein updating the configuration comprises shifting the first image source.

4. The method of claim 1, wherein the device comprises an extended reality device, and wherein the second image source is closer to a bridge of the extended reality device than the first image source.

5. The method of claim 1, wherein the first image source provides a first resolution, and wherein the second image source provides a second resolution.

6. The method of claim 5, wherein the first resolution comprises a higher resolution than the second resolution.

7. The method of claim 1, wherein the first projection occupies a first portion of the surface, and wherein the second projection occupies a second portion of the surface.

8. The method of claim 1, wherein identifying the at least one error in the alignment associated with the first image source based on the first projection and the second projection comprises:
determining an offset of the first projection from the second projection.

9. A computer-readable storage medium having program instructions stored thereon that, when executed by at least one processor, direct the at least one processor to perform a method, the method comprising:
generating a first projection from a first image source, the first projection displayed on a surface of a device;
generating a second projection from a second image source, the second projection displayed on the surface of the device; and
identifying at least one error in an alignment associated with the first image source based on the first projection and the second projection.

10. The computer-readable storage medium of claim 9, wherein the method further comprises:
updating a configuration associated with the first image source based on the at least one error.

11. The computer-readable storage medium of claim 10, wherein updating the configuration comprises shifting the first image source.

12. The computer-readable storage medium of claim 9, wherein the device comprises an extended reality device, and wherein the second image source is closer to a bridge of the extended reality device than the first image source.

13. The computer-readable storage medium of claim 9, wherein the first image source provides a first resolution, and wherein the second image source provides a second resolution.

14. The computer-readable storage medium of claim 13, wherein the first resolution comprises a higher resolution than the second resolution.

15. The computer-readable storage medium of claim 9, wherein the first projection occupies a first portion of the surface, and wherein the second projection occupies a second portion of the surface.

16. The computer-readable storage medium of claim 9, wherein identifying the at least one error in the alignment associated with first image source based on the first projection and the second projection comprises:
determining an offset of the first projection from the second projection.

17. A system comprising:
a computer-readable storage medium;
at least one processor operatively coupled to the computer-readable storage medium; and
program instructions stored on the computer-readable storage medium that, when executed by the at least one processor, direct the at least one processor to perform a method, the method comprising:
generating a first projection from a first image source, the first projection displayed on a surface of a device;
generating a second projection from a second image source, the second projection displayed on the surface of the device; and
identifying at least one error in an alignment associated with the first image source based on the first projection and the second projection.

18. The system of claim 17, wherein the method further comprising:
updating a configuration associated with the first image source based on the at least one error.

19. The system of claim 17, wherein the system further comprises:
the first image source operatively coupled to the at least one processor; and
the second image source operatively coupled to the at least one processor.

20. The system of claim 17, wherein the first image source provides a first resolution, and wherein the second image source provides a second resolution.
